(19) United States
(12) Patent Application Publication
(10) Pub. No.: US 2022/0385677 A1
(43) Pub. Date: Dec. 1, 2022

(54) CLOUD-BASED SECURITY FOR IDENTITY IMPOSTER

(71) Applicant: International Business Machines Corporation, Armonk, NY (US)

(72) Inventors: Vikas Kumar Manoria, Bengaluru (IN); Sudhagar Tiroucamou, Chennai (IN); Ravi Kumar Srirangam, Hyderabad (IN); Vinod Anandram Valecha, Pune (IN)

(21) Appl. No.: 17/335,162

(22) Filed: Jun. 1, 2021

(51) Int. Cl. H04L 29/06; G06N 5/04

(52) U.S. Cl. CPC H04L 63/1416; H04L 63/1491; G06N 5/045

(57) ABSTRACT

A computer-implemented method that secures cloud services from imposters automatically activating an imposter security service (ISS) responsive to receiving an imposter identifier (IID) of an imposter from an identity access and management system (IAMS). The ISS comprises a manipulation mapping table (MMT) that stores configurable factors to assist in control of execution of a cloud service security element (CSSE) in a respective cloud service of the cloud services. The ISS also comprises a decision engine (DE) that interacts with the MMT. The method exchanges imposter security information between the ISS and the CSSE and between the MMT and the DE, and directs the imposter security information to be sent to security information and event management (SIEM).

### BACKGROUND

Disclosed herein is a system and related method for a cloud-based security system for handling an identity imposter. Identity and access management (IAM) is an important part of any enterprise security plan, as it is inextricably linked to the security and productivity of organizations in today's digitally enabled economy. Knowing the importance of identity and IAM protection mechanisms, digital hackers and other improper actors are adopting many ways like phishing, malware attack, social engineering and other low-tech tactics to steal the identities. These stolen identities are normally sold on the dark web to identity hackers who uses these identities to commit illegal activities mostly for financial gains.

### SUMMARY

According to one aspect disclosed herein, a computer-implemented method to secure cloud services from imposters is provided comprising, automatically activating an imposter security service (ISS) responsive to receiving an imposter identifier (IID) of an imposter from an identity access and management system (IAMS). The ISS comprises a manipulation mapping table (MMT) that stores configurable factors to assist in control of execution of a cloud service security element (CSSE) in a respective cloud service of the cloud services. The ISS also comprises a decision engine (DE) that interacts with the MMT. The method exchanges imposter security information between the ISS and the CSSE and between the MMT and the DE, and directs the imposter security information to be sent to security information and event management (SIEM).

Embodiments disclosed herein further comprise an apparatus that is configured to implement the method described above.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1A is a block diagram of a data processing system (DPS) according to one or more embodiments disclosed herein.

FIG. 1B is a pictorial diagram that depicts a cloud computing environment according to an embodiment disclosed herein.

FIG. 1C is a pictorial diagram that depicts abstraction model layers according to an embodiment disclosed herein.

FIG. 2 is a block diagram that illustrates various components of the system that includes an identity access and management system, according to some embodiments.

FIG. 3 is a block diagram that illustrates various components of the system that includes imposter security services and cloud services including a connection layer, according to some embodiments.

FIG. 4A is a block diagram illustrating a cloud service that implements a connecting layer, according to some embodiments.

FIG. 4B is a block diagram illustrating a cloud service that implements use of APIs, according to some embodiments.

FIG. 5 is flowchart illustrating an example process for handing in imposter, according to some embodiments.

### DETAILED DESCRIPTION

The following general acronyms may be used below:

TABLE 1
General Acronyms

| | |
|---|---|
| API | application program interface |
| ARM | advanced RISC machine |
| CD-ROM | compact disc ROM |
| CMS | content management system |
| CoD | capacity on demand |
| CPU | central processing unit |
| CUoD | capacity upgrade on demand |
| DPS | data processing system |
| DVD | digital versatile disk |
| EVC | expiring virtual currency (a virtual currency having an |
| | expiration date, or subject to other virtual currency |
| | usage rules; local virtual currencies with expiration dates) |
| EVCU | expiring virtual currency (units) |
| EPROM | erasable programmable read-only memory |
| FPGA | field-programmable gate arrays |
| HA | high availability |
| IaaS | infrastructure as a service |
| I/O | input/output |
| IPL | initial program load |
| ISP | Internet service provider |
| ISA | instruction-set-architecture |
| LAN | local-area network |
| LPAR | logical partition |
| PaaS | platform as a service |
| PDA | personal digital assistant |
| PLA | programmable logic arrays |
| RAM | random access memory |
| RISC | reduced instruction set computer |
| ROM | read-only memory |
| SaaS | software as a service |
| SLA | service level agreement |
| SRAM | static random-access memory |
| VCUR | virtual currency usage rules |
| WAN | wide-area network |

### Data Processing System in General

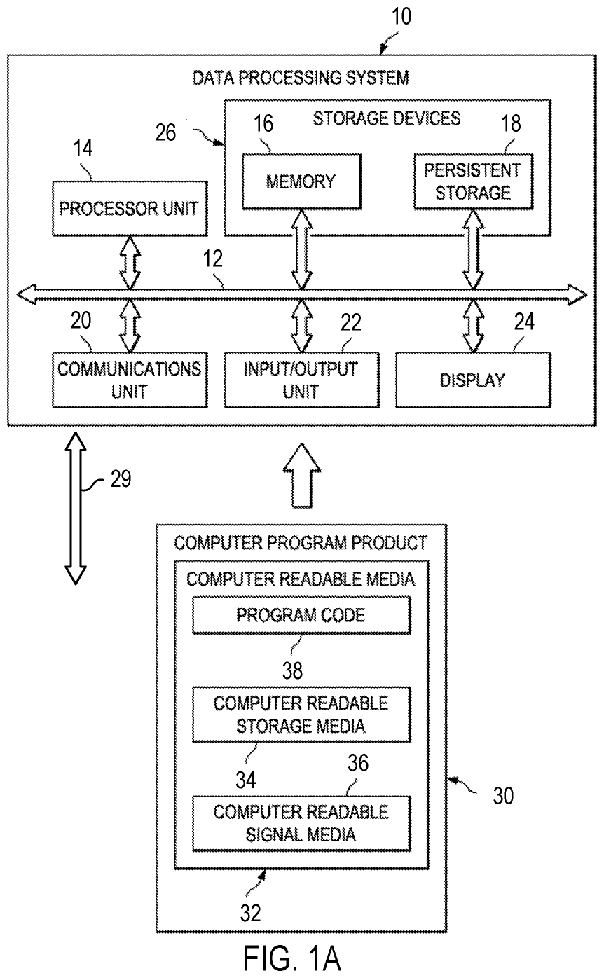

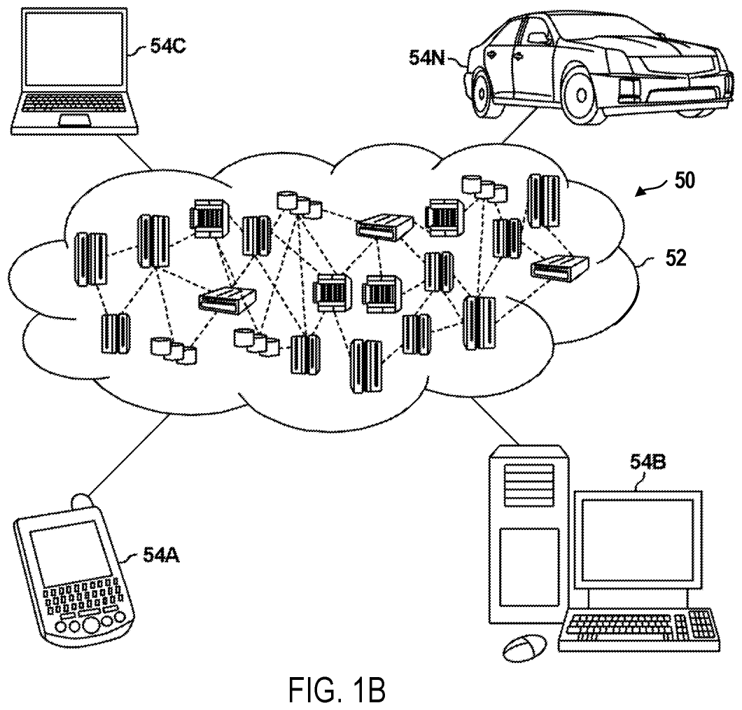

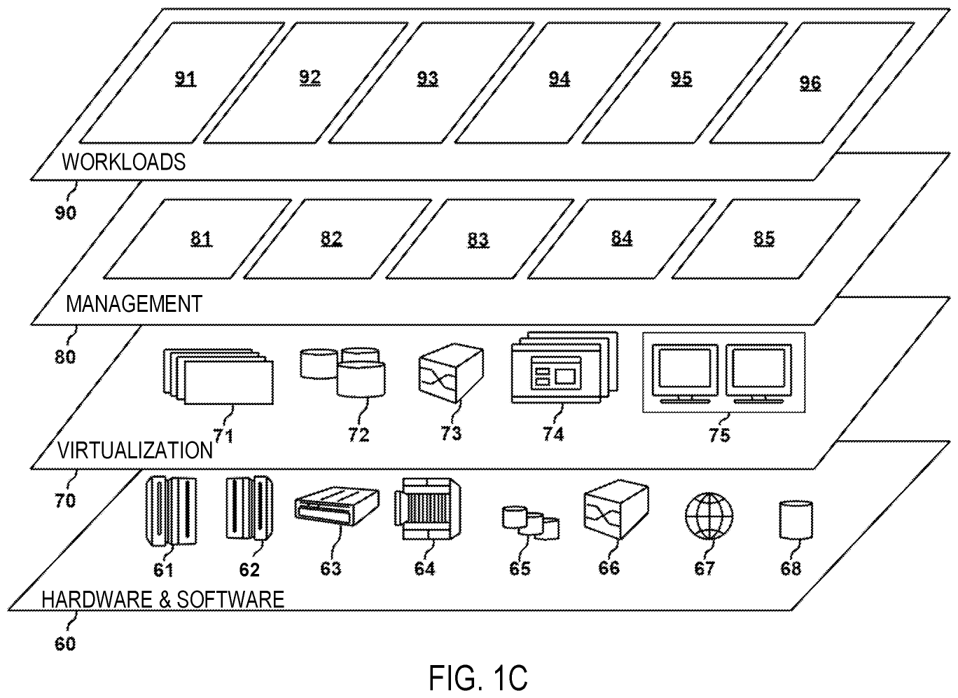

FIG. 1A is a block diagram of an example DPS according to one or more embodiments. In this illustrative example, the DPS 10 may include communications bus 12, which may provide communications between a processor unit 14, a memory 16, persistent storage 18, a communications unit 20, an I/O unit 22, and a display 24.

The processor unit 14 serves to execute instructions for software that may be loaded into the memory 16. The processor unit 14 may be a number of processors, a multi-core processor, or some other type of processor, depending on the particular implementation. A number, as used herein with reference to an item, means one or more items. Further, the processor unit 14 may be implemented using a number of heterogeneous processor systems in which a main processor is present with secondary processors on a single chip. As another illustrative example, the processor unit 14 may be a symmetric multi-processor system containing multiple processors of the same type.

The memory 16 and persistent storage 18 are examples of storage devices 26. A storage device may be any piece of hardware that is capable of storing information, such as, for example without limitation, data, program code in functional form, and/or other suitable information either on a temporary basis and/or a permanent basis. The memory 16, in these examples, may be, for example, a random access memory or any other suitable volatile or non-volatile storage device. The persistent storage 18 may take various forms depending on the particular implementation.

For example, the persistent storage 18 may contain one or more components or devices. For example, the persistent storage 18 may be a hard drive, a flash memory, a rewritable optical disk, a rewritable magnetic tape, or some combination of the above. The media used by the persistent storage 18 also may be removable. For example, a removable hard drive may be used for the persistent storage 18.

The communications unit 20 in these examples may provide for communications with other DPSs or devices. In these examples, the communications unit 20 is a network interface card. The communications unit 20 may provide communications through the use of either or both physical and wireless communications links.

The input/output unit 22 may allow for input and output of data with other devices that may be connected to the DPS 10. For example, the input/output unit 22 may provide a connection for user input through a keyboard, a mouse, and/or some other suitable input device. Further, the input/output unit 22 may send output to a printer. The display 24 may provide a mechanism to display information to a user.

Instructions for the operating system, applications and/or programs may be located in the storage devices 26, which are in communication with the processor unit 14 through the communications bus 12. In these illustrative examples, the instructions are in a functional form on the persistent storage 18. These instructions may be loaded into the memory 16 for execution by the processor unit 14. The processes of the different embodiments may be performed by the processor unit 14 using computer implemented instructions, which may be located in a memory, such as the memory 16. These instructions are referred to as program code 38 (described below) computer usable program code, or computer readable program code that may be read and executed by a processor in the processor unit 14. The program code in the different embodiments may be embodied on different physical or tangible computer readable media, such as the memory 16 or the persistent storage 18.

The DPS 10 may further comprise an interface for a network 29. The interface may include hardware, drivers, software, and the like to allow communications over wired and wireless networks 29 and may implement any number of communication protocols, including those, for example, at various levels of the Open Systems Interconnection (OSI) seven layer model.

FIG. 1A further illustrates a computer program product 30 that may contain the program code 38. The program code 38 may be located in a functional form on the computer readable media 32 that is selectively removable and may be loaded onto or transferred to the DPS 10 for execution by the processor unit 14. The program code 38 and computer readable media 32 may form a computer program product 30 in these examples. In one example, the computer readable media 32 may be computer readable storage media 34 or computer readable signal media 36. Computer readable storage media 34 may include, for example, an optical or magnetic disk that is inserted or placed into a drive or other device that is part of the persistent storage 18 for transfer onto a storage device, such as a hard drive, that is part of the persistent storage 18. The computer readable storage media 34 also may take the form of a persistent storage, such as a hard drive, a thumb drive, or a flash memory, that is connected to the DPS 10. In some instances, the computer readable storage media 34 may not be removable from the DPS 10.

Alternatively, the program code 38 may be transferred to the DPS 10 using the computer readable signal media 36. The computer readable signal media 36 may be, for example, a propagated data signal containing the program code 38. For example, the computer readable signal media 36 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 38 may be downloaded over a network to the persistent storage 18 from another device or DPS through the computer readable signal media 36 for use within the DPS 10. For instance, program code stored in a computer readable storage medium in a server DPS may be downloaded over a network from the server to the DPS 10. The DPS providing the program code 38 may be a server computer, a client computer, or some other device capable of storing and transmitting the program code 38.

The different components illustrated for the DPS 10 are not meant to provide architectural limitations to the manner in which different embodiments may be implemented. The different illustrative embodiments may be implemented in a DPS including components in addition to or in place of those illustrated for the DPS 10.

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1B, illustrative cloud computing environment 52 is depicted. As shown, cloud computing environment 52 includes one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 52 to offer infrastructure, platforms and/or software as services for which a cloud consumer does not need to maintain resources on a local computing device. It is understood that the types of computing devices 54A-N shown in FIG. 1B are intended to be illustrative only and that computing nodes 50 and cloud computing environment 52 can communicate with any type of computerized device over any type of network and/or network addressable connection (e.g., using a web browser).

Referring now to FIG. 1C, a set of functional abstraction layers provided by cloud computing environment 52 (FIG. 1B) is shown. It should be understood in advance that the components, layers, and functions shown in FIG. 1C are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application processing elements 96.

Any of the nodes 50 in the computing environment 52 as well as the computing devices 54A-N may be a DPS 10.

### Computer Readable Media

The present invention may be a system, a method, and/or a computer readable media at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Cloud-Based Security for Identity Imposter

The following application-specific acronyms may be used below:

TABLE 2
Application-Specific Acronyms

| | |
|---|---|
| CL | connection layer |
| CSSE | cloud service security elements |
| DE | decision engine |
| IAM | identity access and management |
| IAMS | identity access and management system |
| ID | identifier, identification |
| IID | imposter's identifier |
| IOC | indicator of compromise |
| IR | incident response |
| ISS | imposter security services |
| ISA | imposter security activity |
| MMT | manipulation mapping table |
| SIEM | security information and event management |
| SOAR | security orchestration |
| SS | security system |
| SSO | single sign-on |
| UI | user interface |

An identity imposter is one who assumes a false identity or title for the purpose of deception. In the computer world, such an imposter is one who improperly uses the identity of another in order to gain improper access to resources on a computer or within a computer network. It is desirable to quickly detect and neutralize an imposter in order to safeguard computer systems and networks.

It is possible to detect imposters in a number of ways, such as through their behavior, access location, or devices being used. Although immediately terminating an improper access may be, in some instances, desirable, this is not always the best course of action. In some instances, it may be desirable to not reject certain accesses by an imposter, but rather to allow the imposter to access various integrated systems in order to learn their plans secretly and gather the concrete evidence required to prosecute the imposter, particularly when insiders are involved. An identity access and management system (IAMS) may be used to detect and deal with hackers and imposters.

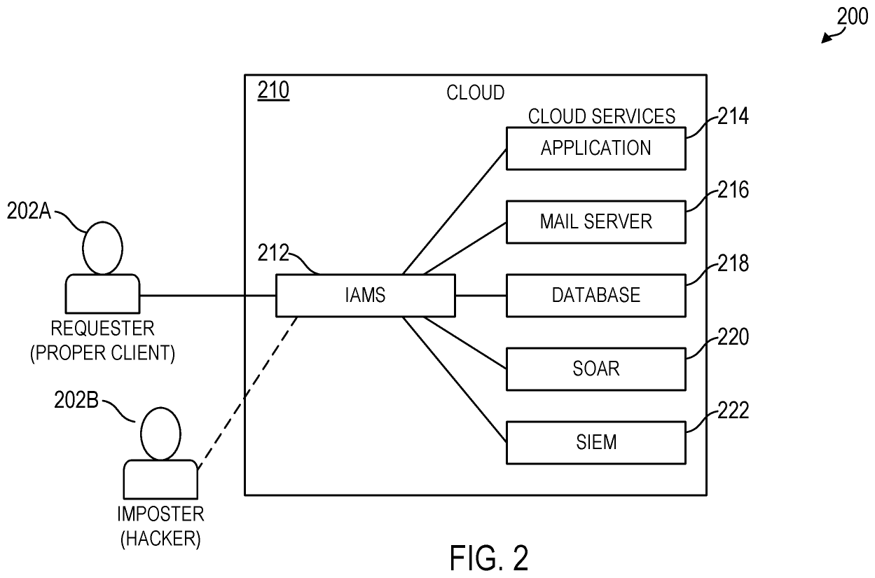

FIG. 2 is a block diagram that illustrates an environment 200 in which the IAMS 212 is implemented within a cloud environment 210. The cloud environment 210 may be, for example, a cloud computing environment 52. The computers and devices that operate within the cloud computing environment 52 may be, e.g., DPSs 10. The cloud 210 may contain a number of elements or services, including, by way of example, an application(s) 214, a mail server 216, a database(s) 218, security orchestration (SOAR) 220, and security information and event management (SIEM) 222.

In normal operation, a normal, proper service requester, or proper client 202A may access the cloud 210 in order to use one of the cloud's integrated elements or services. The IAMS 212 may monitor the access and, upon determining that there appear to be no security issues, allow normal access. Even under such normal circumstances, the IAMS 212 may keep a log of relevant activity, which may be helpful for a variety of reasons, but including the possibility that undetected improper activity has taken place.

However, various embodiments disclosed herein use the IAMS 212 to detect and identify a hacker or an imposter 202B. When such an imposter 202B is detected, the IAMS 212 may, as one of its functions, alert the integrated elements or services of the detection and take further action. Further action may involve simply terminating the imposter 202B once detected. However, the immediate termination may not necessarily be the best action that can be taken. In many instances, it may be advantageous to allow the imposter 202B to attempt various activities while at the same time tracking and logging those activities so that, for example, strong evidence may be collected in the event it is desired to prosecute the imposter 202B. However, rather than allow the imposter 202B access to actual data and/or functionality of the cloud services, which would likely still be detrimental even if the activities could be tracked, it may further prove beneficial if the imposter 202B were given access to fake data and/or functionality of the cloud services. Such actions may be particularly valuable if insiders to a business are involved.

Various embodiments disclosed herein may also use an intermediary subscription-based service for identifying what set of cloud services/processes may be exposed/allowed. The intermediary subscription-based service may also identify the ways through which cloud assets may be protected while allowing these activities covertly and identifying and reporting the malicious intent of the identity imposter 202B. It may achieve this by understanding/monitoring/recording his/her after-intrusion activities with the IAMS 212 integrated cloud services. The IAMS 212 may, upon detecting the identity breach, create an imposter identifier (imposter ID (or IID)) instead of a normal user authentication ID and share the imposter ID with the integrated systems of the cloud 210.

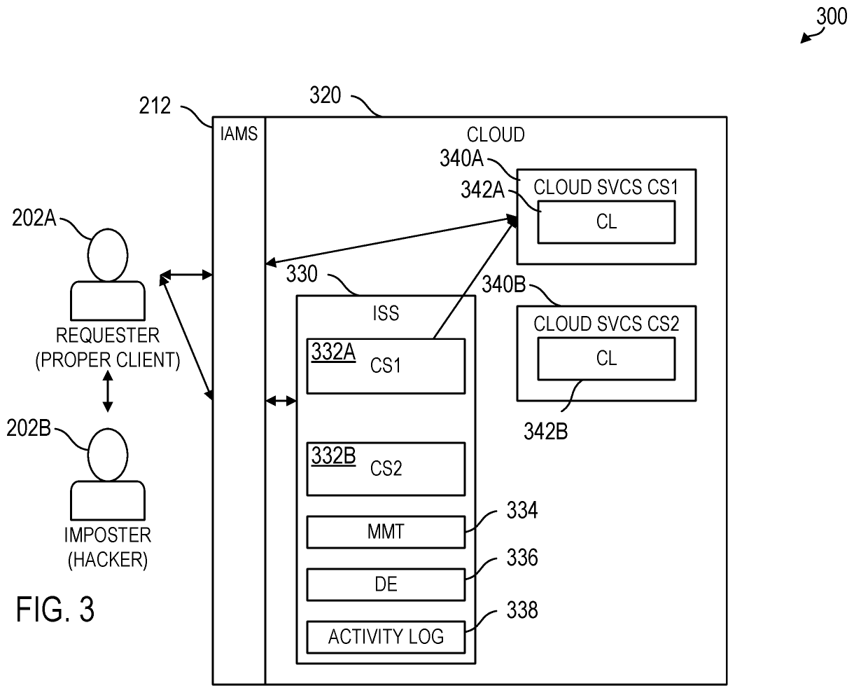

FIG. 3 is a block diagram that illustrates a basic system 300 for an entity who has subscribed to an imposter security service (ISS) 330 (which may be a variant or a part of the IAMS 212). As illustrated, the proper client 202A attempts to log into the cloud 210 in order to properly access a particular cloud service 340A, 340B (collectively or representatively referred to by 340). The proper client 202A may attempt to access the cloud service 340 using an embedded connecting layer (CL) (342A and 342B for cloud service 340A and 340B, respectively) via the IAMS 212, which may include, e.g., a single sign-on (SSO) mechanism. The IAMS 212 may determine that the proper client 202A is, in fact, a proper client and grant normal access to the various cloud services 340 that the proper client 202A has proper access to.

Also as illustrated, when an imposter 202B attempts to log into the cloud 210 in order to improperly access a particular cloud service 340, the IAMS 212 may create an imposter ID, which may then be sent to the ISS 330. The ISS 330 (which may be a subscription-based service) may be automatically triggered upon receiving the imposter's ID from the IAMS 212.

The ISS 330 may, in some embodiments, and using ISS-resident service components 332A, 332B, coupled respectively with the CLs 342A, 342B, implement: a) a manipulation mapping table (MMT) 334, Table 3, which stores configurable factors to dictate and control the working of the CL 342 operations in the respective cloud services 340, and b) a decision engine (DE) 336 that detects a threat severity based on the imposter's 202B past activities, determines the next best action, and updates necessary MMT factors to influence the CL's 342 operations accordingly. The example MMT 334 in Table 3 below illustrates different functions that may be handled differently, based on the determined nature of the imposter.

TABLE 3
Example Manipulation Mapping Table

| | | Risk | Request | Response |
|---|---|---|---|---|
| Function | Imposter | Score | Control | Control |
| login | any | any | none | none |
| read | known user | low | rewrite for | allow as |
| | | | imposter | known |
| read | unknown user | low | no change in | randomize |
| | | | request | output |
| . . . | . . . | . . . | . . . | . . . |
| write | any | any | do nothing | fake confirm |

While the imposter 202B is not aware of covert background activities taken by the ISS 330 and CL 342, the ISS 330 secures the cloud services 340 from the imposter 202B to provide tighter control and a customized response to the imposter's 202B activities by using the CL 342 with exposed ISS 330 functionalities to various service components or constructs. The ISS 330 may utilize the decision engine 336 to find various security patterns and decide a next best action.

The ways through which cloud assets (assets of the cloud services 340) may be protected while allowing these activities covertly and identifying and reporting the malicious intent of the identity imposter 202B may be achieved by understanding/monitoring/recording the imposter's 202B after-intrusion activities with the IAM integrated cloud services 340, 342. This approach may negate the need for use of both an emulated and a production network/system, and thus eliminate the need for an emulated network to be scanned or for a mimicking of an environment. This, in turn may reduce needed resources over such approaches.

In more detail, the system may use the IAMS 212 to detect an incoming user as an identity imposter 202B, and may use an intermediary subscription-based service for identifying what set of cloud services/processes CS1, CS2 (340) may be exposed/allowed and the ways through which cloud assets/services 340 can be protected while allowing these activities covertly and identifying and reporting the malicious intent of the identity imposter 202B by understanding/monitoring/recording his/her after-intrusion activities with the IAM integrated cloud services. This may be achieved by utilizing the CLs 342 that are embedded and enabled in the various cloud services 340 to be secured. The ISS 330 may be triggered by the imposter 202B user ID sent to it by the IAMS 212. The ISS-resident service components 332 may then interact with the CLs 342 to provide the imposter 202B with an artificial experience in interacting with the particular cloud service 342 in a way that does not actually compromise security.

The subscription-based ISS 330 is triggered upon receiving the imposter's 202B ID from the IAMS 212, and the IAMS 212 may further share, as a part of the imposter's 202B ID, the user ID of the proper user 202A who has been hacked, if known, and possible a risk score, such as, e.g., high, medium, and low, or possibly a numerical value representing risk.

The MMT 334 may store configurable factors to dictate and control the working of the CL 342 operations in the respective cloud services 340. The decision engine 336, which detects a threat severity based on the imposter's 202B (or similar imposters) past activities, may determine a next best action, and may update various MMT 334 factors to influence the CLs 342 operations accordingly. The ISS 330 may check the MMT 334 for configurations and mappings related to various cloud services 340 that the imposter 202B can access so that the ISS 330 may start protecting the cloud services 340 without informing the imposter 202B of detection while recording imposter's 202B activities. In some embodiments, the IAM system may mediate, manipulate, and log the imposter's request/response/UI behavior for any cloud service 340 using the CL 342 operations. The CL's 342 operation may be, in some embodiments, dictated and controlled by configurable factors stored in the MMT 334 at the ISS 330 level. In some embodiments, the ISS 330 dynamically determines the next best action to be taken by the CL 340 for a current imposter's 202B request using the DE 336 at the ISS 330 level, which can determine threat severity from the imposter's 202B stored past activities stored in the imposter activity log 338. The ISS 330 may further influence the CL's 342 activity indirectly by updating various MMT 334 factors. When the imposter's 202B sessions close, the DE 336 may share the activities of the imposter 202B, the CL 342 response, threat findings, and recommendations with the IAM for offense investigation. The MMT 334, the DE 336, and the activity log 338 are illustrated as being within the ISS 330, but outside of the cloud service components 332 of the ISS 330. However, the location of the MMT 334, the DE 336, and activity log 338 may be provided within the CS 332 blocks, or at a different location within the cloud 320.

In sum, to deal with imposters 202B, as soon as an IAMS 212 detects an identity breach, it may begin imposter security activity (ISA). The ISA may include, as described above, creating an imposter ID instead of normal user authentication ID and sharing the imposter ID with all integrated systems that may be impacted by the breach. An imposter ID may comprise, for example: 1) the user id that is hacked; 2) a suspected insider id (if a confidence score is high); and 3) a risk score (e.g., high, medium, low) based on detected and calculated risk factors.

The role of having integrated systems in a cloud environment may be of value. On receiving the imposter ID from the IAMS 212, the integrated system may adopt a protection mechanism secretly based on a risk score, and at the same time allow the imposter 202B to access the system without letting the imposter 202B know about their discovery. The system may engage in ISA, such as recording the activity of the imposter, and then, once the session is closed, share relevant activity logs with the IAMS 212 and temporarily disable the user id used for this session. Based on the activity logs received from the integrated systems, the IAM 212 may share the information collected. According to some embodiments, an SS with ISS integrated with an IAM may identify the allowed activities based on imposter ID details, identify what set of cloud services/processes may be exposed and/or allowed, and the ways through which cloud assets may be protected while allowing these activities covertly. The ISS 330 may identify and report the malicious intent of the identity imposter by understanding/monitoring/recording of the identity imposter's after-intrusion activities with the IAMS 212 integrated cloud services, as well as prepare and respond to the threats.

Thus, according various embodiments, an imposter 202B using a stolen user id enters through the IAMS 212, which detects the incoming user as an imposter and allows the imposter 202B to access the imposter-intended service 340 through the ISS 330, instead of giving direct access to the service 340. The ISS 330 is designed to provide security to cloud services from such imposters. The ISS keeps default/customized mappings and configurable factors with the MMT 334 at its end to work with a CL 342 embedded close to a UI layer at each service 340. The CL 342 at every service 340 may be responsible to record, mediate, and manipulate the imposter's request/response/UI behavior with the help of the ISS 330 in order to secure the service 340 and makes the service 340 seem operationally normal to imposter 202B. Upon receiving an imposter request, details from the CL 342, using the MMT 334, returns manipulation commands/script which are performed at the request and response level. While this interaction goes on, the DE 336 and the other components at the ISS 330 level, may work to detect/predict the threat severity/pattern from imposter's past activities across the various cloud services. The DE 336 may also dynamically update various MMT 334 factors related to a risk score or next best action to be taken to further strengthening security at all service levels. Until the imposter sessions are closed, this sequence of operations between the ISS 330 and CL 342 may continue. Finally, the ISS 330 may share the summary of overall imposter activity logs and security measures taken with the IAM 212 for a next action.

This implementation of using the CL 342 is not the only way to protect a cloud service. In some embodiments, the MMT 334 and the DE 336 components at the ISS 330 may also be accessed from low level in-service components through APIs. This alternative implementation method gives the flexibility and tighter control on cloud service operations. There can be services that implement both the MMT 334 and the DE 336, and use them appropriately as needed. The CL 342 and the APIs present on the cloud services 340 may be referred to generically herein as cloud service security elements (CSSEs). In some cloud architectures, various embodiments may include both the CL 342 and APIs. In these embodiments, some further variations may have a particular cloud service 340 using only one of the CL 342 and an API, whereas in other variations, a particular cloud service 340 may use both.

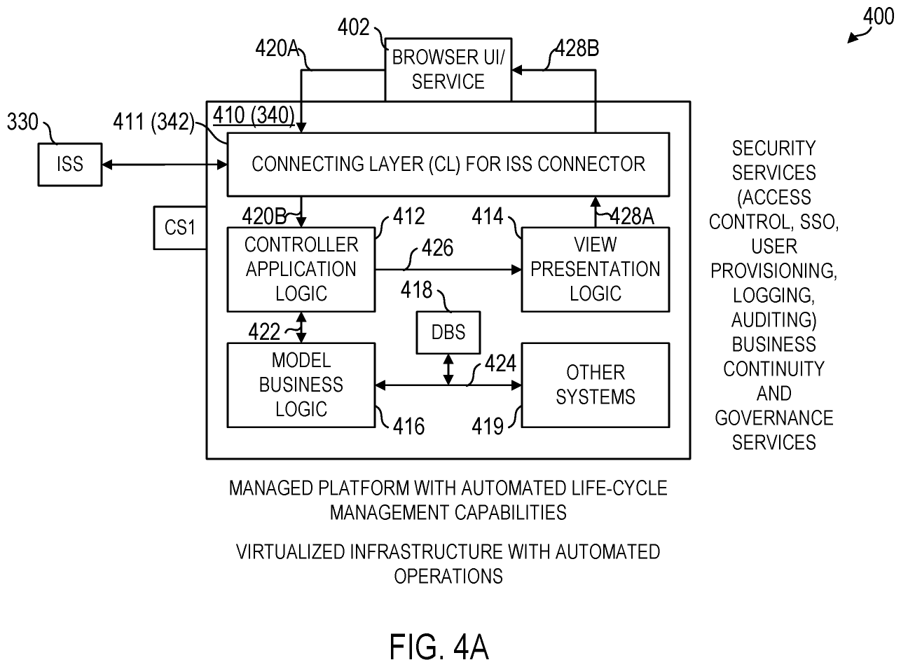

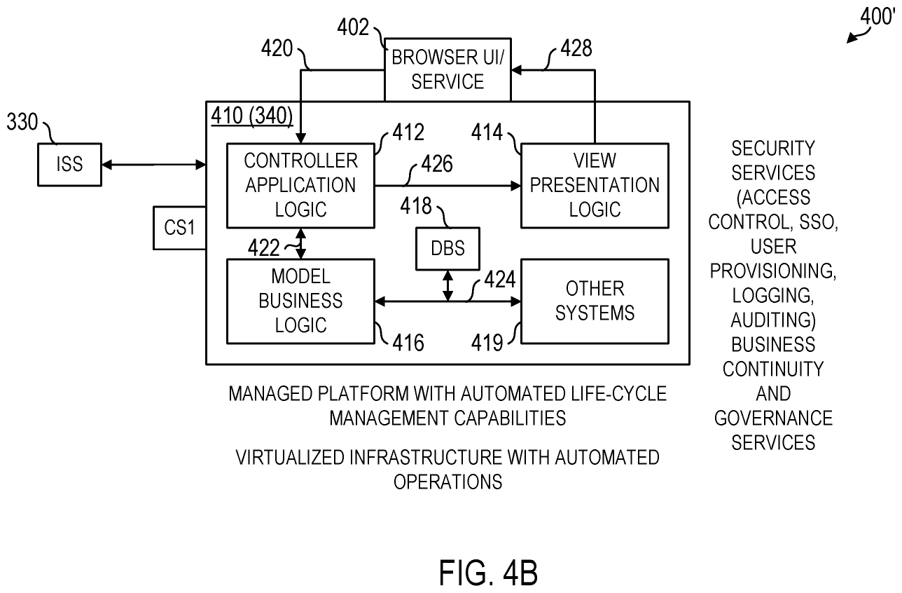

FIGS. 4A and 4B are block diagrams illustrating different cloud service architectures for implementing various embodiments of the cloud-based security described herein. FIG. 4A shows the combined ISS 330 and cloud service 410 (340 in FIG. 3) according to embodiments described above that require a minimal architectural change in the cloud service 410, namely, by the inclusion of the CL 411 (342 in FIG. 3). FIG. 4B, discussed below, requires a major architectural change in the cloud service 410 and does not include the CL 411 requires the use of API calls to achieve the functionality that the CL 410 provides in FIG. 4A.

In FIG. 4A, the CL 411 receives the imposter 202B user request 420A via the browser or other UI 402 service. The CL 411 records UI 402 activities and requests, and manipulates the content going to the UI 402. The CL 411 passes on the manipulated request 420B to controller application logic 412. The controller application logic gathers data and/or updates 422 from the model business logic 416. The model business logic works with 424 integrated servers that may include a DBS 418 and other system 419.

The controller application logic 412 renders obtained information in a way that may be presented to the UI 402 and passes the rendered information 426 to the view presentation logic 414. The view presentation logic 414 passes on the original response 428A to the CL 411. The CL 411 then manipulates the response and sends the manipulated response 428B to the UI 402.

FIG. 4B is a figure similar to FIG. 4A, and like elements are not described again. The primary difference is that there is no CL 411, and thus, implementation of the functionality provided by the CL 411 in FIG. 4B is performed by APIs that are present in the controller application logic 412, the view presentation logic 414, the model business logic 416, the DBS 418, and the other systems 419. However, modifying these elements to incorporate the APIs may require extensive effort. The controller application logic 412 directly receives the user request 420 from the UI 402 and the manipulations may be performed using the API calls. Similarly, the view presentation logic 414 directly manipulates the response and sends the manipulated response 428 to the UI 402.

### Use Case

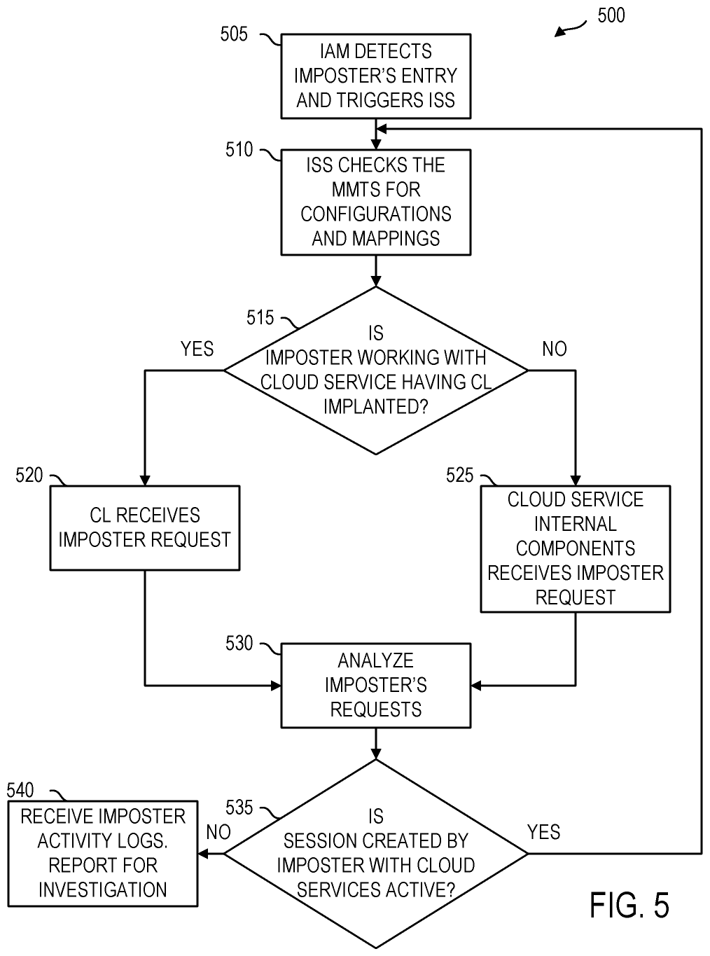

FIG. 5 illustrates a process 500 according to some embodiments, of using cloud-based security for an identity imposter 202B. With regard to the process 500, an illustrative use case is provided as follows. John and Peter work as application support executives at Bank-X's backend office; both are good friends. However, Peter is upset with John because John has recently been given a privileged account to: 1) tackle mission critical defects by directly accessing a production DB; and 2) do external mail communication directly with customers. Both John and Peter have a common friend, Frank, who is working as a loan agent in Bank-Y, a competitor of Bank-X.

To achieve his yearly targets, Frank approaches John and Peter to get some reference customers for marketing Bank-Y's new mortgage loan offering. Frank promises them a good percentage of commissions from his share in case referral customers onboard. John, serving as the proper client 202A in this use case, acts properly and ignores Frank's proposal. Peter, acting as the imposter 202B in this use case, makes up his mind to pursue the opportunity seriously. As expected, this permits Frank to close extra business, resulting in Peter getting additional money from Frank.

The ability to make extra money in this way makes Peter desire to expand his efforts. He plans and agrees with Frank to break into John's set of customer data from the Bank-X production DB, which serves in this use case as a cloud service 340. With the help of malware, Peter successfully steals John's credential and both Peter and Frank plan to explore the cloud-based production DB, without being aware that Bank-X has subscribed to the ISS 330 to protect its cloud services 340. The following illustrates how Bank-X's ISS 330 subscription not only identifies the intentions of Peter and Frank, but also collects enough evidence to make clear the wrongdoing.

On Saturday night, Peter tries logging in as John from his office-provided laptop into the production DB. In operation 505, the IAMS 212 detects a suspected insider threat as an imposter's 202B entry when Imposter Peter logs in as John from his laptop during the weekend. The IAMS 212 may determine this activity is suspicious, using, e.g., historical information about user activity patterns, since John has never logged in using his laptop on weekend days. The IAMS 212 may utilize any type of information, such as devices used to login, times and dates, information about a current location of the user (that the user has granted Bank-X access permission to), or other information, to determine if activity is suspicious or not.

In this particular use case, in order to establish the improper conduct with more certainty, the IAMS 212 contacts John on his mobile app and asks John if he needs access to the production DB today, which John declines. Based on John's response (or, potentially, a lack of a response), the IAMS 212 may determine with near certainty that the attempted login is from one acting as an imposter 202B. Other forms of confirmation may be utilized (secondary passwords or secondary authentication procedures, etc.).

Having received an indication that John does not need access to the production DB today, the IAMS 212 may conclude that this person attempting to login as John (Imposter Peter) is an imposter. The determination of an imposter or not may be based on a probability threshold. In other words, while it may not be absolutely certain that the person seeking access is an imposter, the IAMS 212 may still treat the person as an imposter if indications suggest a certain predetermined probability threshold has been crossed. In most situations, it will be better to have a false positive for an imposter than a false negative, since no harm will be done if the IAMS 212 mistakenly presumes someone to be an imposter who is not.

In response, the IAMS 212 creates an imposter ID (user: John; imposter: Peter; risk score: low), and approves the cloud access, but routed through the ISS 330. In some embodiments, the identity of Imposter Peter may be determined by a number of factors. By way of example, the identity of Imposter Peter may be determined by keyboard and/or mouse user patterns, access location, and/or devices being used. Based on one or more factors (which may be weighted factors), a probability of an assigned imposter identity may be determined. In this case, the risk score may be low, due to the fact that the company knows more about Peter than an outsider and has more control over Peter than it would of outsiders.

In operation 510, the ISS 330 checks the MMT 334 for configurations and mappings of how to handle the imposter 202B for this particular service 340, as well as other various cloud services which Imposter Peter can access. With this information, the ISS 330 can start protecting the cloud services without Imposter Peter knowing that these activities are taking place, and the ISS 330 and/or CL 342 may start recording the activities, responses, etc.

In operation 515, a determination may be made by the ISS 330 as to whether the cloud service 340 has a CL 342 embedded. If not (515:NO), then in some embodiments, in operation 525, the service 340 internal components may receive notice that the request is being made by the imposter (Imposter Peter) 202B and handle the operation itself using, for example, APIs. In some embodiments, the ISS 330 may terminate the imposter's 202B access if the service 240 does not have handlers for an imposter 202B—or, in this situation, may take other steps to deal with the imposter, such as attempting to engage the imposter 202B to provide additional information.

If the cloud service 240 has a CL 342 embedded (515:YES), then, in operation 520, the CL 342 may receive the imposter's 202B request through, e.g., a user interface to the cloud service 240 and handle various aspects of it. Based on the MMT 334 values for the requested operation, the CL 342 may decide how to manipulate responses to the request.

Regardless of whether the CL 342 or the cloud service 340 internal components receive and handle the imposter's 202B request, in operation 530, the request is analyzed in order to determine how to handle the request. The DE 336 at the ISS 330 may analyze the imposter's 202B requests and responses received from various cloud services 340A, 340B, to dynamically detect and determine the threat severity. The imposter's 202B activities may be determined as being attributed to an overarching intent (e.g., steal data, steal money, damage or disrupt the computer systems of the business entity, etc.) This overarching intent can further be used to update the imposter's 202B risk score or other MMT 330 values.

Table 4, depicted below, illustrates an example MMT 334 for the initial imposter 202B login and data access by Imposter Peter. The ISS 330 activates the CL 342A of, e.g., the production DB services cloud service 340, and shares information about received imposter 202B ID with the CL 342A. The CL 342A allows Imposter Peter 202B to login and (from his perspective) appear to be accessing the production DB. The MMT 334 contains entries for the production DB service. As shown in Table 4, the login and write functions for the production DB are handled in the same way, regardless of whether the imposter 202B is a known user or not. No request or response control is necessary, since the response to a login of an imposter 202B is handled in the same way. In response to a write request, the CL 342A does nothing to the production database, but gives the imposter 202B a fake confirmation that the data was written to the production DB.

In operation 535, if the session created by the imposter is still active (535:YES), then the process may return to operation 510 and continue monitoring the activities of Imposter Peter. If the session created by the imposter is ended (535:NO), then the ISS 330 may perform session termination operations that may include activities such as creating and summarizing imposter activity logs for the IAMS 212 as well as security measures that have been taken. The IAMS 212 may then format and report this information to a designated SIEM and/or other stakeholders for investigation.

TABLE 4
MMT Initial Imposter Login and Access
for Use Case Accessing Database Service

| | | Risk | Request | Response |
|---|---|---|---|---|
| Function | Imposter | Score | Control | Control |
| login | any | any | none | none |
| read | known user | any | no change in | randomize |
| | | | request | output |
| read | unknown user | any | route to | no change in |
| | | | dummy table | response |
| write | any | any | do nothing | fake confirm |

In the use case, however, Imposter Peter is not done with his session and now desires to see and copy the data from the CUSTOMER table in the production DB as planned, so he issues a SELECT * request on the CUSTOMER table. The CL 342A receives this request and shares it with the ISS 330. Since Imposter Peter is a known user and the request is a read request, Table 4 indicates that the request is to be allowed to run against the production DB table. Since the response is controlled with a “randomize output”, the CL 342A randomizes all of the numbers with same data type and replaces client names with a false data set. Imposter Peter then copies this randomized data into a file and logs out from the production DB.

TABLE 5
MMT Imposter Communication for Use
Case Accessing E-mail Service

| | | Risk | Request | Response |
|---|---|---|---|---|
| Function | Imposter | Score | Control | Control |
| login | any | any | none | none |
| read mail | known user | any | none | fails due to slow |
| | | | | connectivity |
| read mail | unknown user | any | show dummy | no dummy |
| | | | mails | mail content |
| compose | any | any | none | show mail as sent |
| and send | | | | and fake confirm |
| mail | | | | |
| delete | any | any | hide | fake confirm |
| mail | | | mail | |

Imposter Peter now needs to send this file to Frank, so Imposter Peter compiles an e-mail from John's id, attaches the file, and, using an e-mail service 340B, sends it to Frank. According to Table 5, the response control to this activity is to show the e-mail as being sent (even though the e-mail service 340B has not actually sent it), and to update Imposter Peter's view of his e-mail as having successfully sent the e-mail. Upon receiving the fake confirmation of the “e-mail sent” message, Imposter Peter deletes the mail from sent folder. The CL 342B works as per the MMT 334 configuration entry for the e-mail service 340B in the ISS 330 for the e-mail service 340B.

Imposter Peter considers his efforts using John's ID as successful. The DE 336 at the ISS 330 analyses the sequence of Imposter Peter's activities done with the DB service 340A and the e-mail service 340B, and identifies a security threat case as a serious “data exfiltration to out-of-company entity” case. The DE 336 at the ISS 330 may update the MMT 334 entries to close the existing sessions for services 340A and 340B, and this may be done immediately. The DE 336 may further not allow the imposter to login to any further cloud service unless this ID is unblocked (e.g., automatically or manually) by a security analyst.

In yet another round, Imposter Peter further decides to check the HR application (a further service 340) to find out John's salary. However, since the ISS 330 has now implemented a lockout on Imposter Peter's account, Imposter Peter is now unable to access the salary information due to the technical maintenance cycle kicking-in with regard to the closing of this login ID. In other embodiments, however, the ISS 330 can repeat as before and provide fake information while recording all of the activities that are occurring without implementing the lockout on Imposter Peter's account.

Imposter Peter, having considered the operation a success, calls Frank to share the news and abandons further efforts to use this login ID. In the background, the ISS 330 shares Imposter Peter's activity report (which may, e.g., comprise Peter's executed activities, screen snapshots, and all other IOCs) to the IAMS 212. The IAMS 212 may then automatically take measures, such as raising the case investigation ticket with the IR tool while blocking John's access from Imposter Peter's machine. The organization may now have the evidence it needs to bring legal action against Imposter Peter and Frank.

When the same process is tried by someone who is an outsider and is using some unknown device from outside of the network, the risk score may be high and, accordingly, the activity reach may also be limited by the MMT 334 and the DE 336. In all, the activities performed by both the insider and the outsider may be logged along with any additional information that may be related to their intentions.

### Technical Application

The one or more embodiments disclosed herein accordingly provide an improvement to computer technology. For example, various embodiments described herein represent an improvement to cloud-based security for an identity imposter allows for a more secure and effective network and cloud resource computing environment.

What is claimed is:

1. A method to secure cloud services from imposters, comprising:
automatically activating an imposter security service (ISS) responsive to receiving an imposter identifier (IID) of an imposter from an identity access and management system (IAMS), the ISS comprising:
a manipulation mapping table (MMT) that stores configurable factors to assist in control of execution of a cloud service security element (CSSE) in a respective cloud service of the cloud services; and
a decision engine (DE) that interacts with the MMT;
exchanging imposter security information between the ISS and the CSSE and between the MMT and the DE; and
directing the imposter security information to be sent to security information and event management (SIEM).

2. The method of claim 1, wherein the CSSE is an embedded and enabled connection layer (CL) in the cloud service that is connected to the ISS.

3. The method of claim 2, wherein the decision engine:
determines a threat severity from past imposter activities;
determines a next best action; and
updates the MMT configurable factors to influence security operations of the CSSE accordingly.

4. The method of claim 3, wherein, upon closure of all imposter sessions, the method further comprises sharing, by the DE, activities, threat findings, and recommendations with the IAMS.

5. The method of claim 1, wherein the IAMS:
creates the IID based on suspicious activities of a user that are determined to exceed a predefined threshold of risk.

6. The method of claim 5, wherein the IAMS:
solicits the user for additional information to determine whether to create the IID.

7. The method of claim 1, wherein the MMT comprises instructions for the CSSE to provide a fake confirm in response to the imposter request.

8. The method of claim 1, wherein the MMT comprises instructions for the CSSE to provide randomized output data in a form that normal data would take in response to the imposter request.

9. The method of claim 1, wherein the past imposter activities include past activities of the imposter.

10. The method of claim 1, wherein the CSSE are application program interfaces (APIs) that interact with the MME and DE.

11. The method of claim 1, further comprising, using CSSE operations that are dictated and controlled by the configurable factors:
manipulating a request of the imposter for the cloud service;
manipulating a response to the imposter that is responsive to the request; and
logging the request and the response.

12. The method of claim 1, wherein the IID comprises:
a user ID that is hacked;
a suspected insider ID; and
a risk score.

13. The method of claim 1, wherein the cloud services include a database access service and an email service.

14. An apparatus to secure cloud services from imposters, comprising:
a memory; and
a processor that is configured to:
automatically activate an imposter security service (ISS) responsive to receipt of an imposter identifier (IID) of an imposter from an identity access and management system (IAMS), the ISS comprising:
a manipulation mapping table (MMT) that stores configurable factors to assist in control of execution of a cloud service security element (CSSE) in a respective cloud service of the cloud services; and
a decision engine (DE) that interacts with the MMT;
exchange imposter security information between the ISS and the CSSE and between the MMT and the DE; and
direct the imposter security information to be sent to security information and event management (SIEM).

15. The apparatus of claim 14, wherein:
the CSSE is an embedded and enabled connection layer (CL) in the cloud service that is connected to the ISS; and
the decision engine is configured to:
determine a threat severity from past imposter activities;
determine a next best action; and
update the MMT configurable factors to influence security operations of the CSSE accordingly.

16. The apparatus of claim 14, wherein:
upon closure of all imposter sessions, the DE is configured to share, activities, threat findings, and recommendations with the IAMS; and
the IAMS creates the IID based on suspicious activities of a user that are determined to exceed a predefined threshold of risk;
the IID comprises a user ID that is hacked, a suspected insider ID, and a risk score.

17. The apparatus of claim 14, wherein the MMT comprises instructions for the CSSE to provide:
a fake confirm in response to the imposter request; and
randomized output data in a form that normal data would take in response to the imposter request.

18. The apparatus of claim 17, wherein the processor is further configured to use CSSE operations that are dictated and controlled by the configurable factors to:
manipulate a request of the imposter for the cloud service;
manipulate a response to the imposter that is responsive to the request; and
log the request and the response.

19. A computer program product comprising:
one or more computer readable storage media, and program instructions collectively stored on the one or more computer readable storage media, the program instructions comprising program instructions to:
automatically activate an imposter security service (ISS) responsive to receipt of an imposter identifier (IID) of an imposter from an identity access and management system (IAMS), the ISS comprising:
a manipulation mapping table (MMT) that stores configurable factors to assist in control of execution of a cloud service security element (CSSE) in a respective cloud service of the cloud services; and
a decision engine (DE) that interacts with the MMT;
exchange imposter security information between the ISS and the CSSE and between the MMT and the DE; and
direct the imposter security information to be sent to security information and event management (SIEM).

20. The computer program product of claim 19 wherein the program instructions further configure the processor to:
determine a threat severity from past imposter activities;
determine a next best action; and
update the MMT configurable factors to influence security operations of the CSSE accordingly.
wherein the program instructions are further configured to, upon closure of all imposter sessions, share activities, threat findings, and recommendations with the IAMS.
